(19) United States
(12) Patent Application Publication
(10) Pub. No.: US 2003/0163335 A1
(43) Pub. Date: Aug. 28, 2003

(54) Method of creating a mental impression of compatible industrial automation devices

(76) Inventors: Jean-Louis Droulin, Andover, MA (US); Jean-Marc Tixador, Villeneuve Loubet (FR)

Correspondence Address: Wallenstein & Wagner, Ltd., 53rd Floor, 311 S. Wacker Drive, Chicago, IL, 60606-6630, US

(21) Appl. No.: 10/077,564

(22) Filed: Feb. 15, 2002

(51) Int. Cl. G06F 17/60

(52) U.S. Cl. 705/1

(57) ABSTRACT

A method for suggesting a transparent factory concept is disclosed. The method includes creating mental impression of compatible industrial automation devices. The housings of the devices are substantially transparent and create a visual impression and promote the visual impression of substantially transparent housings to create a mental image of compatibility.

### TECHNICAL FIELD

The present invention is related to the marketing and brand identifying of industrial automation devices.

### BACKGROUND OF INVENTION

Typically, particular industrial automation devices have a unique look and therefore they do not appear, on their face, compatible with other industrial automation devices.

For one selling multiple types of industrial automation devices which are compatible, there is a need to develop a mental impression on a consumer or user that such devices are compatible.

This invention is directed to solving this and other problems.

### SUMMARY OF THE INVENTION

It is an object of the invention to provide a method for creating a mental impression of compatible industrial automation devices.

In accordance with the invention, the devices are housed in substantially transparent housings to create a visual impression, and the visual impression is promoted as indicative of compatibility to create the mental impression of compatible industrial automation devices.

It is contemplated that the housings are tinted, preferably a shade of green.

It is further contemplated that portions of the housings are not substantially transparent. Preferably, the transparent portion of the housing would be combined with a front face plate that is not substantially transparent.

It is still further contemplated that the devices are operatively interconnected.

Other advantages and aspects of the present invention will become apparent upon reading the following description of the drawings and detailed description of the invention.

### BRIEF DESCRIPTION OF DRAWINGS

FIG. 1 is a diagram of an exploded housing of one device indicating the substantially transparent aspect of the housing;

FIG. 2 shows devices in substantially transparent housings linked together; and

FIG. 3 is a drawing of a transparent housing with internal components visible.

### DETAILED DESCRIPTION OF PREFERRED EMBODIMENT

While this invention is susceptible of embodiments in many different forms, there is shown in the drawings and will herein be described in detail a preferred embodiment of the invention with the understanding that the present disclosure is to be considered as an exemplification of the principles of the invention and is not intended to limit the broad aspect of the invention to the embodiment illustrated.

The present invention is directed to a method of creating a mental impression of compatible industrial automation devices.

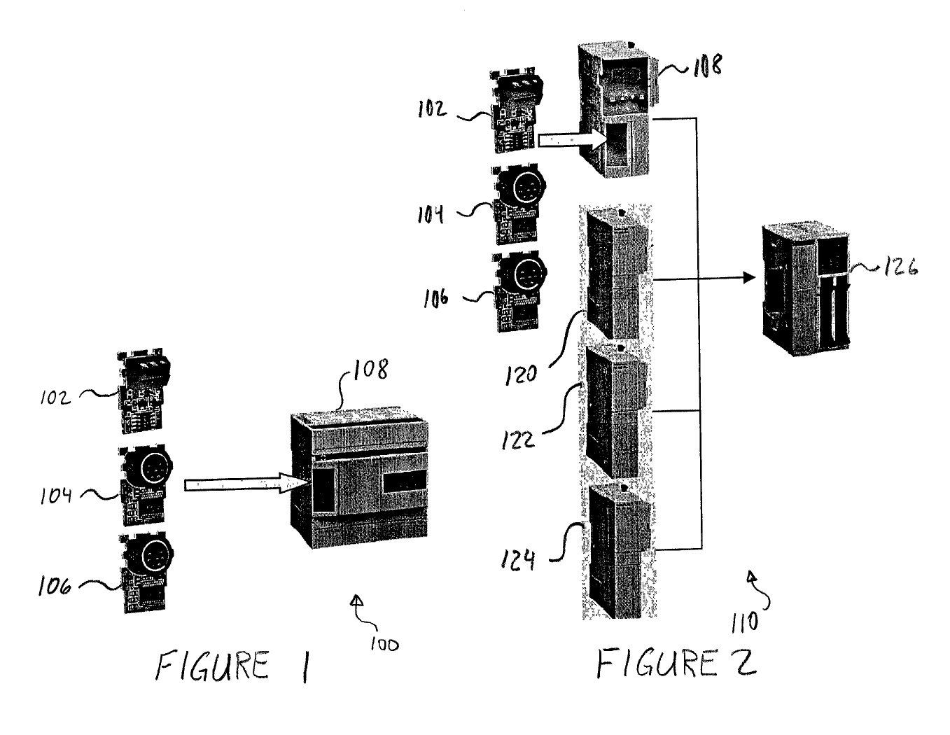

A typical industrial automation device 100, such as a programmable logic controller, is illustrated in FIG. 1. The device 100 includes one or more components 102, 104, and 106 which reside within a substantially transparent housing 108. The components 102, 104, and 106 can be visually seen through the substantially transparent housing 108. The components 102, 104, and 106 occupy the housing 108 and their presence and placement are observable by one viewing the device 100.

Referring to FIG. 2, industrial automation devices 108, 120, 122, 124, and 126 are communicatively linked and interconnected together by a conventional network bus 128. Device components 102, 104, and 106 residing in device 108 are the components to be plugged into the housing. Other industrial automation devices 120, 122, 124, and 126 are present in this configuration. The devices 118, 120, 122, 124, and 126 each include housings which are substantially transparent to create and promote a perception, to a purchaser and/or user of the devices, indicative of compatibility.

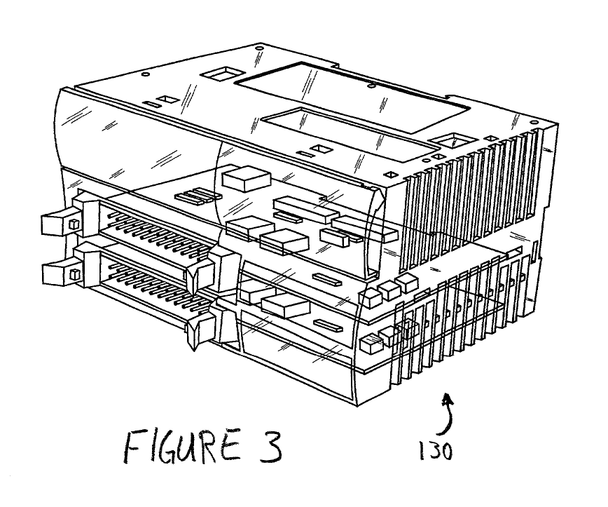

Referring now to FIG. 3, a transparent industrial automation device housing 130 has its internal components visible. The transparent housings may be tinted a uniform color, preferably green. Portions of the housings potentially are not substantially transparent. For example, the housing may have a face plate that is not substantially transparent.

While the specific embodiment has been illustrated and described, numerous modifications come to mind without significantly departing from the spirit of the invention, and the scope of protection is only limited by the scope of the accompanying claims.

We claim:

1. A method of creating a mental impression of compatible industrial automation devices, the method comprising:
housing the devices in substantially transparent housings to create a visual impression; and
promoting the visual impression as indicative of compatibility to create the mental impression of compatible industrial automation devices.

2. The method of claim 1 wherein the transparent housings are tinted.

3. The method of claim 2 wherein the housings are tinted a shade of green.

4. The method of claim 1 wherein portions of the housings are not substantially transparent.

5. The method of claim 4 wherein the housings have a front face plate and the front face plates are not substantially transparent.

6. A method of formulating a mental impression of compatible industrial automation devices, the method comprising:
housing the devices in substantially transparent housings to formulate a visual impression;
operatively interconnecting the devices; and
promoting the visual impression as indicative of compatibility to formulate the mental impression of compatible industrial automation devices.

7. The method of claim 6 wherein the transparent housings are tinted.

8. The method of claim 7 wherein the housings are tinted a shade of green.

9. The method of claim 6 wherein portions of the housings are not substantially transparent.

10. The method of claim 9 wherein the housings have a front face plate and the front face plates are not substantially transparent.
